(19) United States
(12) Patent Application Publication
(10) Pub. No.: US 2024/0210267 A1
(43) Pub. Date: Jun. 27, 2024

(54) METHOD FOR SETTING UP AN ACOUSTIC LEAK DETECTION SYSTEM

(71) Applicant: Kamstrup A/S, Skanderborg (DK)

(72) Inventors: Sune Hoveroust DUPONT, Skanderborg (DK); Lars CHRISTIANSEN, Skanderborg (DK)

(21) Appl. No.: 18/556,000

(22) PCT Filed: Mar. 30, 2022
(86) PCT No.: PCT/EP2022/058455

§ 371 Date: Oct. 18, 2023

(30) Foreign Application Priority Data
Apr. 21, 2021 (EP) 21169574.7

(51) Int. Cl. G01M 3/24

(52) U.S. Cl. CPC G01M 3/243

(57) ABSTRACT

The invention refers to a method for setting up an acoustic leak detection system in a fluid distribution network characterized by the following steps:
placing at least one first acoustic sensor (10) in the network
placing at least one acoustic signal generator (26) in the network at a location distanced to the at least one first acoustic sensor (10) along a pipe (4),
generating an acoustic signal by the acoustic signal generator (26)
evaluating whether the at least one first acoustic sensor (10) detects said generated acoustic signal, and
in case that said generated acoustic signal is not detected by said at least one first acoustic sensor (10), placing at least one second acoustic sensor (24) in the network at a location less distant along the pipe from the location of the signal generator (26) than said at least one first acoustic sensor (10).

### CROSS REFERENCE TO RELATED APPLICATIONS

This application is a United States National Phase Application of International Application PCT/EP2022/058455, filed Mar. 30, 2022, and claims the benefit of priority under 35 U.S.C. § 119 of European Application 21169574.7, filed Apr. 21, 2021, the entire contents of which are incorporated herein by reference.

### TECHNICAL FIELD

The invention refers to a method for setting up an acoustic leak detection system in a fluid distribution network, in particular a liquid distribution network.

### BACKGROUND

It is known to arrange acoustic sensors in a liquid distribution network as an acoustic leak detection system. In particular, it is known to place acoustic sensors on the main distribution pipes of the network for detection of leaks in the pipes of the network on the basis of occurring noise. When installing the acoustic sensors there it is the problem to optimize the positioning of the sensors such that, preferably, the entire network can be monitored, and to minimize the number of acoustic sensors needed.

It is the object of the invention to provide a method for setting up an acoustic leak detection system in a fluid, in particular liquid distribution network which allows to minimize the number of necessary sensors on the one side and to ensure on the other side that the entire network can be monitored for detection of possible leaks.

This object is achieved by a method having the features defined. Preferred embodiments are defined in the following description and the accompanying drawings.

### SUMMARY

The method according to the invention is used for setting up an acoustic leak detection system in a fluid, in particular liquid distribution network like a water distribution network or a heat distribution network. The network consists of several pipes for fluid or liquid distribution. Preferably, the network comprises main distribution pipes and branching distribution pipes and branching pipes connecting single points of consumption, like for example single houses.

According to the method at least one first acoustic sensor is placed in the network. The acoustic sensor, in particular, is an acoustic sensor suitable for acoustic leak detection, i.e., provided to detect noise occurring from a leakage. In particular, the sensor can detect noise in a frequency range in which noise occurring from a leakage can be expected. Such a first acoustic sensor preferably is attached directly to a pipe of the network or to a component or device connected to a pipe or may be integrated into such a component or device. Thus, preferably the at least one first acoustic sensor is in contact with the pipe such that noise transferred via the wall of the pipe and/or inside the liquid flowing through the pipe can be detected by said at least one first acoustic sensor.

Furthermore, at least one acoustic signal generator is arranged in the network at a location distanced to the at least one first acoustic sensor, i.e. distanced along a pipe length. The signal generator is placed on a pipe such that an acoustic signal generated by the signal generator is transferred via the pipe and the liquid in the network. In a following step, there is generated an acoustic signal by the acoustic signal generator, the acoustic signal being in a frequency range detectable by said at least one first acoustic sensor, i.e., preferably in a frequency range which is characteristic for leaks to be detected. The acoustic signal generator preferably comprises an electronic signal oscillator with an amplifier and a loudspeaker. In a following step, it is evaluated whether the at least one first acoustic sensor detects such generated acoustic signal, i.e. the acoustic signal produced by the signal generator. In case that such acoustic signal from the signal generator cannot be detected by said at least one first acoustic sensor, this is an indication that the acoustic signal generator is placed too far away from the first acoustic sensor, measured along the pipes of the distribution network. Thus, a leakage occurring in the area in which the sound generator has been placed would not be detected by said at least one first acoustic sensor. Therefore, according to the invention at least one second acoustic sensor is placed in the network at a location between said at least one first acoustic sensor not receiving the acoustic signal and said signal generator, measured along the pipe length of the network. The at least one second acoustic sensor is placed less distant from the position of the signal generator. This means the at least one second acoustic sensor is placed closer to the location of the acoustic signal generator than the first acoustic sensor, seen along the pipes of the distribution network. By placing at least one second acoustic sensor in the network at such a position acoustic blind spots in the network are reduced or avoided as it is ensured that sound occurring from leakages at any position in the network can be detected by at least one acoustic sensor, either at least one first acoustic sensor and/or at least one second acoustic sensor. The acoustic sensors may be connected to a leak detection or evaluation system as known in the art to localize a leakage inside the distribution network on basis of the sound or noise detected by one or more of the sensors arranged in the network. Such a leak detection or evaluation system preferably is implemented as a software in a Head End System (HES) at the water works.

In case that said acoustic signal generated by the signal generator is detected by said at least one first acoustic sensor placed in the network, no second acoustic sensor has to be placed at the location of the acoustic signal generator or in an area close to the location of the acoustic signal generator, respectively. In this case sound occurring from a leakage in said area where the sound generator has been placed can be detected by the at least one first acoustic sensor. Thus, there is no need for placing a second acoustic sensor in this area or between the location of the sound generator and the first acoustic sensor. By this method it is possible to reduce the number of acoustic sensors required.

According to a possible embodiment of the method there is placed at least one second acoustic sensor in said network prior to generating the acoustic signal by said acoustic signal generator. In case that said acoustic signal is not detected by said at least one first acoustic sensor or said at least one second acoustic sensor, then, there is placed at least one further second acoustic sensor in the network at a location which is less distant along the pipe from the location of the signal generator than the distance to said at least one first acoustic sensor and said at least one second acoustic sensor placed in the network. This means, the at least one further second acoustic sensor is placed closer to the location of the other acoustic sensors, seen along the extension of the pipes of the distribution network. By this embodiment of the method, it can be ensured that noise occurring from a leakage in the system can be detected by either a first or a second acoustic sensor in the network. To discover remaining blind spots, which may be eliminated by the arrangement of a further acoustic sensor, both the first and the second acoustic sensors already placed in the network can be used, i.e., it is evaluated whether an acoustic signal from the signal generator is received by a first or second sensor already placed in the network.

Preferably the amplitude of the acoustic signal received by the at least one first acoustic sensor and/or at least one second acoustic sensor is evaluated for determining the optimum location of a further second acoustic sensor in the network. Thus, for example at least a minimum amplitude should be detected by the sensor to ensure a secure leak detection. Preferably, the at least one second acoustic sensor or the one further second acoustic sensor is placed at a location along the pipe where an amplitude of an acoustic signal, which is output by the signal generator arranged at the same location and received by said at least one first acoustic sensor, is above a predefined minimum and preferably reaches a maximum or is close to a maximum. For example, the signal generator may be placed at different locations and the amplitudes of the signals received by the different sensors are compared for the different positions of the signal generator. Then in the next step a further second acoustic sensor may be placed at the optimum position, for example at the position of the signal generator for which one or more of the sensors detect a signal above a predefined minimum and further preferably a maximum amplitude or an amplitude close to a maximum. Preferably, at least a predefined minimum amplitude should be detected by the sensor to ensure that a leak at the respective position would be detected.

The at least one first acoustic sensor and/or an acoustic signal generator may be incorporated into a flow meter or at least one ultrasonic flow meter in said fluid distribution network may be used as a first acoustic sensor and/or used as an acoustic signal generator, wherein the flow meter preferably is located inside a branch pipe of the network. This may, in particular, be a branch pipe connecting a point of consumption like a single house. According to this embodiment of the method, flow meters arranged in the network to detect and meter the fluid consumption, can be used for leakage detection in addition. For this purpose, additional sensing elements for noise detection may be integrated into the flow meter and/or ultrasonic sensors used for flow detection may be used for noise detection, too. The branch pipes in the network may be pipes made from plastic material and the first acoustic sensors may be optimized to detect noise being conducted via those branch pipes, in particular branch pipes made from plastic material.

According to a preferred embodiment for leakage detection those sensors inside the flow meters are used in addition to second acoustic sensors placed separately inside the fluid distribution network. In a fluid distribution network, all the flow meters placed in the network may be used for noise detection, i.e. as first acoustic sensors. Alternatively, only a certain number of flow meters may be provided with such noise detection functionality allowing to use the flow meters as first acoustic sensors as described.

The at least one second acoustic sensor preferably is an acoustic sensor independent from a flow meter, preferably comprising a microphone or an accelerometer. In particular, the second acoustic sensor may be an independent device provided for noise detection only, so called data loggers. Preferably, such at least one second acoustic sensor is placed on a wall of a distribution pipe of the network, in particular a main distribution pipe of the network, or inserted through the wall into the fluid. In the latter case hydrophones may be used. Such a distribution pipe for example may be made from metal. The distribution pipe may be a pipe from which further pipes branch off. The at least one second acoustic sensor preferably is connected to the pipe at a location at which a further device is placed in the pipe, for example a valve. This allows to use existing access points for arranging the at least one second acoustic sensor on a pipe of the network.

The at least one first acoustic sensor and said at least one second acoustic sensor preferably are connected to an analysis or evaluation system, preferably via a wireless signal connection. The evaluation system may comprise a central computing device carrying out the described evaluation. The evaluation system, furthermore, may comprise a mobile or handheld device allowing a control by an operator locally in the field. Such a mobile device may be connected to a central evaluation or computing device. Alternatively, the mobile device may be in direct communication with the acoustic sensors to directly carry out the evaluation.

Preferably, the evaluation system comprises a mobile device visualizing the evaluation result, in particular on a display. Such a mobile device may be used by an operator in the field. Preferably, the visualization on a display shows the entire network, for example in form of a map indicating the locations of all the sensors and the signal generators in the network. Such a visualization may help the operator to find the optimum locations for placing second acoustic sensors in the system to avoid blind spots and at the same time minimizing the number of second acoustic sensors required.

In a possible solution said at least one acoustic signal generator may be connected and controlled by an evaluation system, in particular a central evaluation system. By such a connection the evaluation system may initiate the output of an acoustic signal by the acoustic signal generator or sound generator, respectively. Furthermore, the evaluation system or evaluation device may, then, directly receive a feedback from one or more of the first acoustic sensors and/or second acoustic sensors already placed in the system to evaluate which of the sensors can receive the acoustic signals output by the signal generator. Then, the result may be presented on a display to an operator and/or an automatic evaluation may be carried out showing at which point in the network further acoustic sensors, in particular second acoustic sensors should be placed to allow acoustic leakage detection in the entire network. This means according to this embodiment the at least one acoustic signal generator and the acoustic sensors, in particular the first acoustic sensors placed in the system may be synchronized by a central evaluation system or evaluation device. However, in alternative solutions such synchronization can be avoided. In an embodiment using an unsynchronized acoustic signal generator, the signal or sound generator may be installed and started either by the evaluation system or an operator. The signal generator may then be left for generating an acoustic signal or sound for a longer period, for example for one or several days, e.g., up to ten days.

According to a further possible embodiment said at least one acoustic signal generator may generate an acoustic signal identifying or characterizing said acoustic signal generator, i.e. being characteristic for said signal generator. For example, the signal generator may produce a predefined sound pattern being characteristic for the signal generator and which pattern can be identified by an acoustic sensor and/or an evaluation or control device evaluating signals from said sensor. For example, the sound pattern may consist of predefined phases of sound generation and silence which alternate. As an example, there may be a phase of sound generation having a predefined duration followed by a predefined phase of silence, and so on. For example, the sound generator may produce noise for six hours followed by three hours of silence and again followed by noise for six hours and so on. Such a sound pattern can be detected by the acoustic sensor without the need of synchronization with the signal generator. The sound pattern is chosen such that it clearly distinguishes over the usual noise in the system, i.e. can be identified by a suitable evaluation system. The detection or identification of the pattern may be carried out directly in the acoustic sensor, preferably a flow meter serving as an acoustic sensor. Alternatively or in addition, the sound pattern or characteristics of the sound signal produced by the sound generator may be detected by an external evaluation system, in particular a central evaluation system. The acoustic signal received by the acoustic sensor, in particular the flow meter, or a signal representing said acoustic signal, respectively, may for example be transferred to the evaluation device and the detection of the signal being characteristic for the sound generator may be carried out by the evaluation device. I.e. the respective analysis can be made in a head end system. By this method the system can be simplified since a synchronization of the sensors and the signal generator is not necessary.

In case that the analysis or evaluation shows the need for placing a further second acoustic sensor into the network, preferably, said at least one second acoustic sensor is placed at a location within a predefined or calculated distance, along the pipes of the network, to the location of the acoustic signal generator used for this evaluation step. Further preferably, the at least one second acoustic sensor is placed along a pipe between the location of the signal generator and the acoustic sensor, in particular the first acoustic sensor which could not receive the signal produced by the acoustic signal generator.

After the described analysis of the network for placing the necessary acoustic sensors, preferably the acoustic signal generator is removed from the fluid distribution network. This is preferable with a separate acoustic signal generator. In case that the acoustic signal generator is integrated into another component used in the distribution network, for example in a flow meter, the signal generator may remain in the network. In case that the signal generator is removed, it may be used at a different location of the network or in another distribution network for evaluating the need of further acoustic sensors for leakage detection.

The acoustic signal generator preferably generates an acoustic signal in a frequency range detectable by said at least one first acoustic sensor and said at least one second acoustic sensor, further preferable it generates a signal in a frequency range which is used for acoustic leakage detection. Thus, for evaluating the need of further acoustic sensors a sound signal is used which is in the frequency range of the noise which must be detected for leakage detection. Preferably, also the signal amplitude is chosen to correspond to the amplitude of a leakage noise.

The acoustic signal generator may generate a white noise signal and/or generate a signal in a frequency range between 10 Hz and 2 kHz. This is a preferred frequency region. However, the invention is not limited to this frequency region. The signal generated could be a single frequency, for example a 1 kHz signal. However, there is a risk of loosing such narrow band signal due to unforeseen resonances, coupling phenomena or acoustic damping by the pipe walls. Especially plastic pipes have a high damping. Therefore, the signal generated should preferably comprise several frequency components chosen in the frequency range between 10 Hz and 2 kHz.

The at least one acoustic signal generator may continuously output an acoustic signal. However, according to a possible embodiment the acoustic signal is generated by the signal generator for a predefined time period, for example a period of 30 seconds to one minute. An interruption of the signal output by the signal generator may enhance the analysis or signal detection by the acoustic sensors and/or a connected evaluation device, respectively.

The at least one first acoustic sensor, the at least one second acoustic sensor and/or said at least one acoustic signal generator may be battery powered. This simplifies the installation in the network, as no external power supply is required. In particular, if flow meters or flow consumption meters are used as acoustic sensors it is preferred that these flow meters are battery powered. This on the other hand requires an optimization of the method in view of the power consumption. The method preferably should be carried out with a minimized power consumption to preferably not decrease the lifetime of the flow meters depending on the battery lifetime. As described earlier, in the particular case where a flow meter or ultrasonic flow meter is also acting as an acoustic signal generator, for example with a loudspeaker integrated, the battery should be larger than used in normal flow meters, say a big D-cell lithium battery for example. Preferably, in a network one large-battery-signal-generating flowmeter per 10 to 50 houses is estimated as sufficient.

According to a further preferred option during the evaluation or analysis of the need of further acoustic sensors, the water distribution network preferably is brought into a stable state to reduce or avoid changes in noise occurring in the system or network because of other reasons, i.e. produced by further aggregates in the system. For example, pumps or valves in the system may produce noise. In this case it is preferred to set such pumps or valves in a stable condition. Furthermore, additionally or alternatively noise sources in the network may be brought into an operational condition producing the maximum noise, for example pumps may be set in a full load mode generating a high flow noise and/or pumping noise. When analyzing the system for the need of additional acoustic sensors at a maximum noise level, it can be ensured that even at high noise a leakage detection is possible. In case that the acoustic sensors can hear the acoustic signal produced by the acoustic signal generator during a high noise level then, they will later be able to hear noise at less busy flow levels, too.

According to a preferred embodiment of the invention flow meters which are configured to serve as acoustic sensors are placed in the network. It is possible to provide all flow meters with a possibility to detect acoustic noise in the system. Alternatively, flow meters provided for acoustic leak detection are placed at critical points in the system, only. The use of such special flow meters avoids further, second acoustic sensors in the network, or reduces the number of them. Preferably, mainly those flow meters are used for leakage detection in the fluid or liquid distribution network. Thus, preferably first the flow meters having the acoustic leak detection properties are placed in the network and then the described method is carried out to evaluate at which further locations additional, second acoustic sensors are required to cover the entire network for acoustic leakage detection. By this method, the number of necessary additional, second acoustic sensors can be minimized and flow meters having acoustic leak detection properties can be used instead of special sensors whenever possible.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

### In the Drawings:

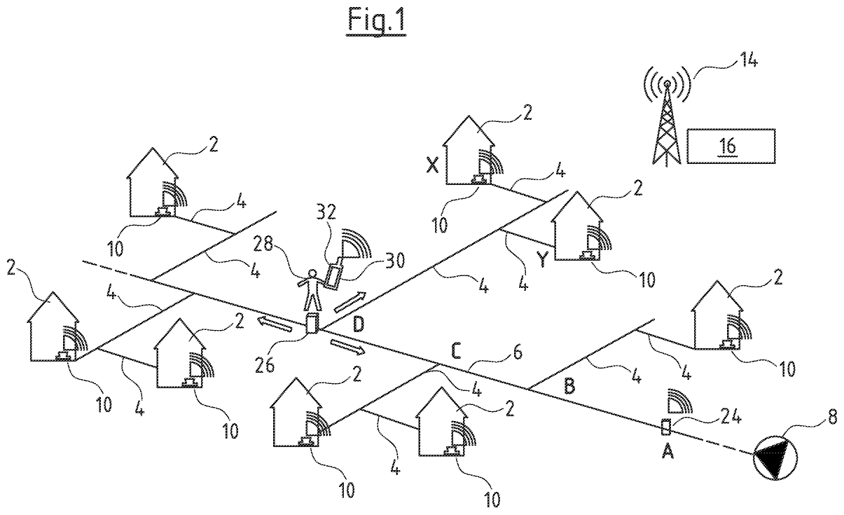

FIG. 1 is a water distribution network according to the invention, and

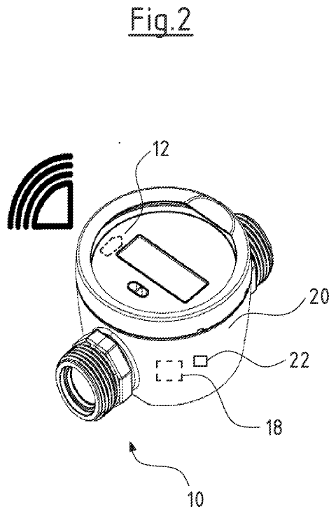

FIG. 2 is a flow meter serving as a first acoustic sensor.

### DESCRIPTION OF PREFERRED EMBODIMENTS

Referring to the drawings, FIG. 1 shows an example of a water distribution network for distributing water to different points of consumption, here shown as houses 2. The houses 2 are connected via branching pipes or branch pipes 4, which lead to a main distribution pipe 6. The water in the main distribution pipe 6 and, thus, in the entire network is delivered by a pumping device 8. At each point of consumption, i.e. in each of the houses 2 there is provided a flow meter 10 for metering the water consumption. The flow meters 10 may be ultrasonic flow meters detecting the flow by an ultrasonic sensor. The flow meters 10 are provided for wireless radio communication, i.e. include a wireless communication module 12. The wireless communication modules 12 connect the flow meters 10 via a communication network 14 to a control or evaluation device 16, i.e. a head end system. Additionally, the flow meters may include for example near field communication technology (NFC) for communicating with a handheld device. In some embodiments the flow meters 10 may have a bidirectional communication capability.

The flow meters 10 include flow sensors, in this example an ultrasonic flow sensor 18 inside the housing 20. Additionally or alternatively, the housing 20 may include a separate noise or acoustic sensor 22. By use of the ultrasonic sensor 18 or the acoustic sensor 22 the flow meter 10 may serve as a first acoustic sensor detecting acoustic noise in the branch pipes 4. The detected noise or signals derived from the detected noise are transferred via the wireless communication module 12 to the control or evaluation device 16. This preferably is the same wireless communication link which is used to transfer the metering results, i.e. the metered water consumption to the central control device 16. The noise detection function inside the flow meters 10 may be optimized to detect noise transferred by the branch pipes 4, which usually are small pipes often made from plastic material. The flow meters 10 serving as first acoustic sensors allow to listen inside the water distribution network to detect leakages inside the distribution network, i.e. outside the houses 2, on basis of the occurring noise. Thus, the flow meters 10 having a noise detection functionality are used instead of separate acoustic sensors for leakage detection in the network, i.e. allow to reduce the necessary number of those separate acoustic sensors for leakage detection. It would be ideal if for leakage detection the entire fluid distribution network could be covered by those first acoustic sensors in form of the flow meters 10. Usually, in a large and complex fluid distribution network, however, it is not possible to cover the entire network, i.e. there are remaining blind spots or areas in which noise cannot be detected by the flow meters 10 which are placed at the ends of the branch pipes 4, i.e. at the points of consumption in houses 2.

In those areas further acoustic sensors, namely second acoustic sensors 24 are arranged. These second acoustic sensors 24 are configured for noise detection only and may comprise a microphone, for example. In this example at point A such a second acoustic sensor 24 is arranged. The second acoustic sensor 24 is provided with a wireless communication module allowing to connect to the communication network 14 and to the control or evaluation device 16. Thus, noise signals or more precisely sound signals detected by the second acoustic sensor 24 or information derived from those signals can be transferred to the control or evaluation device 16 and used for leakage detection in the network. These second acoustic sensors 24 are used in connection with the noise detection property of the flow meters 10 to localize leakages inside the network by noise detection. Characteristic acoustic signals which occur upon leakage are transmitted or conducted via the pipes towards the sensors 10, 24 and are detected by the first acoustic sensors (flow meters 10) and the second acoustic sensors 24. It is possible to localize a leakage by considering which of the sensors receives or hears the respective noise characteristic for a leakage.

To find the locations at which the second acoustic sensors 24 must be placed to avoid blind spots in the network, an acoustic signal generator 26 is used. The signal generator 26 may for example be placed by an operator 28 at a position which in the operator's opinion may be critical for leakage detection. Preferably, the acoustic signal generator 26 is placed on the pipe, in this example the main distribution pipe 6 at a location where the pipe is accessible, for example at the position of a valve inside the network. In this example the acoustic signal generator 26 is placed at the position D. The acoustic signal generator 26 outputs an acoustic signal in the frequency range which is considered for acoustic leakage detection. Then, the operator 28 analyses which of the first acoustic sensors, i.e. the flow meters 10 detects the acoustic signal output by the acoustic signal generator 26. The operator 28 in this example uses a handheld device 30, for example a software application on a smartphone. The handheld device 30 has a wireless communication module allowing a direct wireless communication with the communication module 12 of the flow meters 10, the acoustic signal generator 26 and/or via the communication network 14 with the sensor control or evaluation device 16. The operator 28 may start the output of the acoustic signal by the signal generator 26 directly himself, by direct communication with the acoustic signal generator 26 or via the control device 16. In this case the signal generator 26 may comprise a communication module allowing the communication with the central control device 16.

In case that this acoustic signal produced by the signal generator 26 can be received by at least one of the flow meters 10, it is not necessary to place a further second acoustic sensor 24 at the position D. However, in case that neither one of the flow meters 10 nor the second acoustic sensor 24, which are already placed in the network, can detect the acoustic signal output by the acoustic signal generator 26, then the operator 28 could decide to place a further second acoustic sensor 24 at the position D. This method may be carried out for further points in the network, for example at points B and C shown in FIG. 1.

The handheld device 30 comprises a display 32 which may visualize the entire network to the operator 28, in particular showing all of the acoustic sensors, i.e. the flow meters 10 serving as first acoustic sensors and the second acoustic sensors 24. The display 32 may directly visualize which sensors 10 receive an acoustic signal generated by the signal generator 26.

Instead of such a manual evaluation there may be a software application inside the handheld device 30 and/or the central control device 16 evaluating at which positions second acoustic sensor 24 must be placed. The central control device 16 may inform the operator 28, for example via the handheld device 30, at which location the acoustic signal generator 26 should be placed for the evaluation process.

To further improve the acoustic leakage detection during evaluation, whether and where additional second acoustic sensors 24 are necessary, preferably the pumping device 8 and possibly further devices are set into their operational state producing a maximum of noise in the network. Thus, it is ensured that also in such operational state acoustic leakage detection can be ensured.

The described method allows to make a leakage detection in the entire network mainly by use of the flow meters 10 having leakage detection modules and to just place additional second acoustic sensors 24 in the network where necessary, i.e. at those locations or in those areas to which the flow meters 10 cannot listen. Thus, the number of necessary second acoustic sensors 24 can be minimized, and the essential part of the acoustic leakage detection can be provided by the flow meters 10 which are needed at the point of consumption, anyway.

While specific embodiments of the invention have been shown and described in detail to illustrate the application of the principles of the invention, it will be understood that the invention may be embodied otherwise without departing from such principles.

### LIST OF REFERENCE NUMERALS

2 houses, points of consumption
4 branch pipe
6 main distribution pipe
8 pumping device
10 flow meters, first acoustic sensors
12 wireless communication module
14 communication network
16 control or evaluation device
18 flow sensor
20 housing
22 acoustic sensor
24 second acoustic sensor
26 acoustic signal generator
28 operator
30 handheld device
32 display
A, B, C, D locations inside the fluid distribution network

1. A method for setting up an acoustic leak detection system in a fluid distribution network, the method comprising the following steps:
placing at least one first acoustic sensor in the network;
placing at least one acoustic signal generator in the network at a location distanced along a pipe to the at least one first acoustic sensor;
generating an acoustic signal by the acoustic signal generator;
evaluating whether the at least one first acoustic sensor detects said generated acoustic signal; and
in case that said generated acoustic signal is not detected by said at least one first acoustic sensor, placing at least one second acoustic sensor in the network at a location less distant measured by pipe length from the location of the signal generator than the distance of said at least one first acoustic sensor to the signal generator.

2. The method according to claim 1, wherein in case that said generated acoustic signal is detected by said at least one first acoustic sensor no second acoustic sensor is placed at the location of the acoustic signal generator.

3. The method according to claim 1, further comprising placing at least one initial second acoustic sensor in said network prior to generating the acoustic signal by said acoustic signal generator and in case that said acoustic signal is not detected by said at least one first acoustic sensor or said at least one initial second acoustic sensor, placing said at least one second acoustic sensor, as at least one further second acoustic sensor in the network at said location less distant measured by pipe length from the location of the signal generator than the distance of said at least one first acoustic sensor to the signal generator, as a location less distant along the pipe from the location of the signal generator than said at least one first acoustic sensor and also less distant along the pipe from said at least one initial second acoustic sensor previously placed in the network.

4. The method according to claim 3, wherein the at least one initial second acoustic sensor or the one further second acoustic sensor is placed at the location along the pipe where an amplitude of an acoustic signal received by said at least one first acoustic sensor is above a predefined minimum.

5. The method according to claim 1, wherein said at least one first acoustic sensor and/or said at least one acoustic signal generator are incorporated into a flow meter or at least one ultrasonic flow meter in said fluid distribution network is used as the first acoustic sensor and/or as the acoustic signal generator.

6. The method according to claim 1, wherein said at least one second acoustic sensor is an acoustic sensor independent from a flow meter.

7. The method according to claim 1, wherein said at least one second acoustic sensor is placed on a distribution pipe of the network.

8. The method according to claim 1, wherein said at least one first acoustic sensor and said at least one second acoustic sensor are connected to an evaluation system.

9. The method according to claim 8, wherein said evaluation system comprises a mobile device visualizing the evaluation result.

10. The method according to claim 1, wherein said at least one acoustic signal generator is connected to and controlled by an evaluation system.

11. The method according to claim 1, wherein said at least one acoustic signal generator generates an acoustic signal identifying said acoustic signal generator, by a predefined sound pattern.

12. The method according to claim 1, wherein said at least one acoustic generator is removed from the fluid distribution network after evaluating the necessity of arranging a second acoustic sensor.

13. The method according to claim 1, wherein said at least one acoustic signal generator generates an acoustic signal in a frequency range detectable by said at least one first acoustic sensor and said at least one second acoustic sensor.

14. The method according to claim 1, wherein said at least one acoustic signal generator generates a white noise signal and/or generates a signal in a frequency range between 10 Hz and 2 kHz.

15. The method according to claim 1, wherein said acoustic signal is generated by said at least one acoustic signal generator for a period of 30 seconds to one minute.

16. The method according to claim 1, wherein the at least one first acoustic sensor, the at least one second acoustic sensor and/or said at least one acoustic signal generator are battery powered.

17. The method according to claim 5, wherein the flow meter is located inside a branch pipe of the network.

18. The method according to claim 6, further said acoustic sensor independent from said flow meter comprises a microphone and/or an accelerometer.

19. The method according to claim 7, wherein the distribution pipe is made from metal.

20. The method according to claim 8, wherein said at least one first acoustic sensor and said at least one second acoustic sensor are connected to an evaluation system via a wireless signal connection.
